(19) United States
(12) Patent Application Publication
(10) Pub. No.: US 2006/0035942 A1
(43) Pub. Date: Feb. 16, 2006

(54) Fungicidal combinations of active substances

(76) Inventors: Ulrike Wachendorff-Neumann, Neuwied (GB); Astrid Mauler-Machnik, Leichlingen (GB); Manfred Jautelat, Burscheid (GB); Graham Holmwood, Leuverkusen (GB)

Correspondence Address: NORRIS, MCLAUGHLIN & MARCUS, P.A., 875 THIRD AVE, 18TH FLOOR, NEW YORK, NY, 10022, US

(21) Appl. No.: 10/518,669

(22) PCT Filed: Nov. 6, 2003
(86) PCT No.: PCT/EP03/06107

§ 371 Date: Jul. 21, 2005

(30) Foreign Application Priority Data
Jun. 24, 2002 (DE) 102 28 103.3

(51) Int. Cl. A01N 43/64; A01N 37/44; A01N 37/12

(52) U.S. Cl. 514/359; 514/384; 514/567

(57) ABSTRACT

The present invention relates to a novel fungicidally active compound combination of 2-[α-{[(α-methyl-3-trifluoromethylbenzyl)imino]oxy}-o-tolyl]glyoxylic acid methyl ester O-methyl oxime of the formula (I) 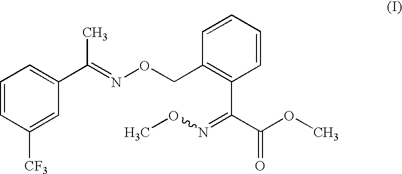 and the active compounds of formulae (II) and (III) mentioned in the disclosure.

The present invention relates to a novel active compound combination which comprises, on the one hand, the known 2-[α-{[(α-methyl-3-trifluoromethyl-benzyl)imino]oxy}-o-tolyl]glyoxylic acid methyl ester O-methyl oxime and, on the other hand, further known active compounds and is highly suitable for controlling phytopathogenic fingi.

It is already known that 2-[α-{[(α-methyl-3-trifluoromethylbenzyl)imino]oxy}-o-tolyl]glyoxylic acid methyl ester O-methyl oxime has fungicidal properties (cf. EP-A-460 575). The activity of this substance is good; however, at low application rates it is sometimes unsatisfactory.

Furthermore, it is already known that numerous azole derivatives can be used for controlling fungi (cf. Pesticide Manual, 11^{th} Edition (1997), page 1144; WO 96/16048). However, the activity of these compounds, too, is not always satisfactory at low application rates.

It has now been found that the novel active compound combination comprising
2-[α-{[α-methyl-3-trifluoromethylbenzyl)imino]oxy}-o-tolyl]glyoxylic acid methyl ester O-methyl oxime of the formula (I) 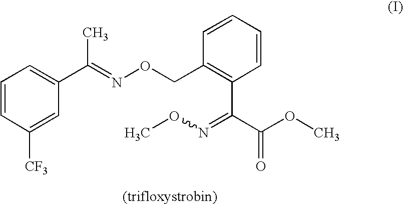
   and
(1) the compound of the formula (II) 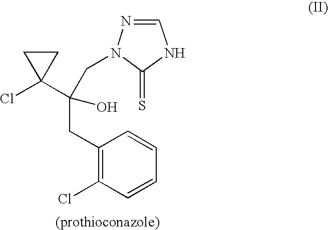
   and
(2) the compound of the formula (III) 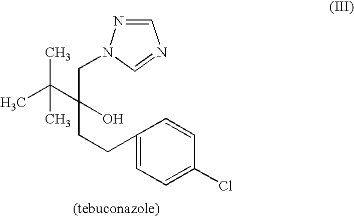
   has very good fungicidal properties.

Surprisingly, the fungicidal action of the active compound combination according to the invention comprising the three active compounds is considerably higher than the sum of the actions of the individual active compounds or the action of the prior-art mixtures of in each case two active compounds. Thus, an unforeseeable true synergistic effect is present, and not just an addition of activities.

The components present in the active compound combination according to the invention in addition to the active compound of the formula (I) are likewise known. Specifically, the active compounds are described in the following publications:
Compound of the formula (I): EP-A-460 575
Compound of the formula (II): WO 96/16048
Compound of the formula (III): EP-A-040 345

The following active compound combinations are likewise known:
Active compound combination comprising compounds of the formulae (I) and (II): WO 97/00012
Active compound combination comprising compounds of the formulae (II) and (III): WO 98/47367

If the active compounds in the active compound combination according to the invention are present in certain weight ratios, the synergistic effect is particularly pronounced. However, the weight ratios of the active compounds in the active compound combination can be varied within a relatively wide range.

In general,
0.1-10 parts by weight, preferably 0.2-5 parts by weight, of active compound of the formula (II) and
0.1-10 parts by weight, preferably 0.2-5 parts by weight, of active compound of the formula (III)
   are present per part by weight of active compound of the formula (I).

The active compound combination according to the invention has very good fungicidal properties and can be employed for controlling phytopathogenic fungi, such as Plasmodiophoromycetes, Oomycetes, Chytridiomycetes, Zygomycetes, Ascomycetes, Basidiomycetes, Deuteromycetes, etc.

The active compound combination according to the invention is particularly suitable for controlling cereal diseases, such as Erysiphe, Cochliobolus, Pyrenophora, Rhynchosporium, Septoria, Fusarium, Pseudocercosporella and Leptosphaeria and for controlling fungal infections of non-cereal crops such as vine, fruits, groundnuts, vegetables, for example Phythophthora, Plasmopara, Pythium, and powdery mildew fungi, such as, for example, Sphaerotheca or Uncinula, and causative organisms of leaf spot, such as Venturia, Altemaria and Septoria, and also Rhizoctonia, Botrytis, Sclerotinia and Sclerotium.

The fact that the active compound combination is well tolerated by plants at the concentrations required for controlling plant diseases permits the treatment of above-ground parts of plants, of propagation stock and seeds, and of the soil. The active compound combination according to the invention can be employed for foliar application or else as seed dressing.

The active compound combination according to the invention may also be employed to increase the harvest yield. Moreover, it has reduced toxicity and is tolerated well by plants.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeder's certificates. Parts of plants are to be understood as meaning all above-ground and below-ground parts and organs of plants, such as shoot, leaf, flower and root, examples which may be mentioned being leaves, needles, stems, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

The active compound combination according to the invention can be converted to the customary formulations, such as solutions, emulsions, suspensions, powders, foams, pastes, granules, aerosols and microencapsulations in polymeric substances and in coating compositions for seeds, and ULV formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Essentially, suitable liquid solvents include: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water. Liquefied gaseous extenders or carriers are to be understood as meaning those liquids which are gaseous at ambient temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other additives can be mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95% by weight of active compounds, preferably between 0.5 and 90%.

The active compound combination according to the invention, as such or in its formulations, can also be applied in a mixture with known fungicides, bactericides, acaricides, nematicides or insecticides, to broaden the activity spectrum or to prevent the development of resistance, for example.

A mixture with other known active compounds such as herbicides or with fertilizers and growth regulators is also possible.

The active compound combination can be used as such, in the form of its formulations or as the use forms prepared therefrom, such as ready-to-use solutions, emulsifiable concentrates, emulsions, suspensions, wettable powders, soluble powders and granules. They are used in the customary manner, for example by watering, spraying, atomizing, scattering, spreading, and as a powder for dry seed treatment, a solution for seed treatment, a water-soluble powder for seed treatment, a water-soluble powder for slurry treatment, or by encrusting.

When using the active compound combination according to the invention, the application rates can be varied within a relatively wide range, depending on the kind of application. In the treatment of parts of plants, the application rates of active compound combination are generally between 0.1 and 10 000 g/ha, preferably between 10 and 1 000 g/ha. In the treatment of seeds, the application rates of active compound combination are generally between 0.001 and 50 g per kilogram of seed, preferably between 0.01 and 10 g per kilogram of seed. In the treatment of the soil, the application rates of active compound combination are generally between 0.1 and 10 000 g/ha, preferably between 1 and 5 000 g/ha.

The good fungicidal activity of the active compound combination according to the invention is evident from the examples below. While the individual active compounds exhibit weaknesses with regard to fungicidal activity, the combinations of three active compounds have an activity which exceeds the sum of individual activities.

In fungicides, a synergistic effect is always present when the fungicidal activity of the active compound combination exceeds the total of the activities of the active compounds when applied individually.

The expected activity for a given combination of 2 or 3 active compounds can be calculated according to S. R. Colby (“Calculating Synergistic and Antagonistic Responses of Herbicide Combinations”, Weeds 1967, 15, 20-22) as follows:

If

X is the efficacy when applying active compound A at an application rate of m g/ha,
Y is the efficacy when applying active compound B at an application rate of n g/ha,
Z is the efficacy when applying active compound C at an application rate of r g/ha,
E₁ is the efficacy when applying the active compounds A and B at application rates of m and n g/ha, respectively, and
E₂ is the efficacy when applying the active compounds A and B and C at application rates of m and n and r g/ha, respectively,
then

$${E}_{1} = X + Y - \frac{X \cdot Y}{100}$$

and for a combination of three active compounds:

$${E}_{2} = X + Y + Z - \frac{X \cdot Y - X \cdot Z - Y \cdot Z}{100} + \frac{X \cdot Y \cdot Z}{10000}$$

The efficacy is calculated in %. 0% is an efficacy which corresponds to that of the control, whereas an efficacy of 100% means that no infection is observed.

If the actual fungicidal activity exceeds the calculated value, then the activity of the combination is superadditive, i.e. a synergistic effect exists. In this case, the efficacy which was actually observed must be greater than the value for the expected efficacies E₁ and E₂ calculated from the abovementioned formula.

The example that follows illustrates the invention. However, the invention is not limited to the example.

### EXAMPLE A

Pyrenophora teres Test (Barley)/Curative

Solvent: 25 parts by weight of N,N-dimethylacetamide
Emulsifier: 0.6 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for curative activity, young plants are sprayed with a conidia suspension of Pyrenophora teres. The plants remain in an incubation cabin at 20° C. and 100% relative atmospheric humidity for 48 hours. The plants are then sprayed with the preparation of active compound at the stated application rate.

The plants are placed in a greenhouse at a temperature of about 20° C. and a relative atmospheric humidity of about 80%.

Evaluation is carried out 7 days after the inoculation. 0% means an efficacy which corresponds to that of the control, whereas an efficacy of 100% means that no infection is observed.

TABLE A
Pyrenophora teres test (barley)/curative

| | Application rate | |
|---|---|---|
| | of active | |
| Active compound | compound in g/ha | Efficacy in % |
| Known: | | |
| Ex. (I) | 100 | 67 |
| Ex. (II) | 100 | 56 |
| Ex. (III) | 100 | 22 |
| Mixture according to the invention: | | |
| Ex. (I) + Ex. (II) + Ex. (III) | 35 + 30 + 35 | 78 |
| (10:8.5:10) | | |

1-5. (canceled)

6. An active compound combination comprising a compound of formula (I) 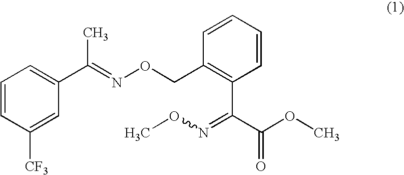
and
(1) a compound of formula (II) 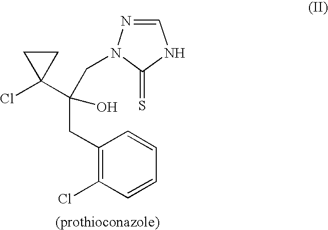
and
(2) a compound of formula (III)

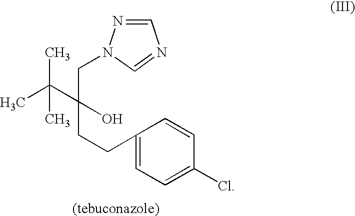

7. An active compound combination in which the weight ratio of the compound of formula (I) to the compound of formula (II) is from 1:0.1 to 1:10 and the weight ratio of the compound of formula (I) to the compound of formula (III) is from 1:0.1 to 1:10.

8. A method for controlling fungi comprising allowing an effective amount of an active compound combination according to claim 6 to act on the fungi and/or their habitat.

9. A process for preparing fungicidal compositions comprising mixing one or more active compound combinations according to claim 6 with one or more extenders and/or surfactants.
